(19) United States
(12) Patent Application Publication
(10) Pub. No.: US 2015/0283914 A1
(43) Pub. Date: Oct. 8, 2015

(54) METHOD AND SYSTEM FOR VEHICLE BATTERY ENVIRONMENT CONTROL

(71) Applicant: Ford Global Technologies, LLC, Dearborn, MI (US)

(72) Inventors: Mark Douglas Malone, Canton, MI (US); William Najib Mansur, West Bloomfield, MI (US); Daniel Paul Roberts, Livonia, MI (US); Bonnie Elias Savaya, West Bloomfield, MI (US)

(73) Assignee: Ford Global Technologies, LLC, Dearborn, MI (US)

(21) Appl. No.: 14/245,925

(22) Filed: Apr. 4, 2014

(51) Int. Cl. B60L 11/18; B60J 1/00; B60J 7/02; B60K 1/04

(52) U.S. Cl. CPC B60L 11/1874; B60K 1/04; B60J 1/00; B60J 7/02

(57) ABSTRACT

Methods and system for controlling conditions within an enclosure housing a vehicle propulsion energy source are described. In one example, vehicle windows, vents, and shades may be operated to reduce an amount of energy used to maintain conditions within an enclosure housing a vehicle propulsion source. The systems and methods may be at least incorporated into electric and hybrid vehicles.

### FIELD

The present description relates to methods and a system for improving control of an environment within a vehicle battery enclosure. The methods and system may be useful for conserving energy stored in a battery.

### BACKGROUND AND SUMMARY

A battery enclosure for a battery used to propel a vehicle may provide battery cells within the battery enclosure protection from ambient outdoor conditions such as rain, snow, warm ambient outdoor temperatures, and cold ambient outdoor temperatures. The battery enclosure may be packaged underneath the vehicle and between vehicle wheels to protect the battery enclosure and improve vehicle driving dynamics. In some examples, the battery enclosure may include an environmental controller for maintaining conditions within the battery enclosure within a desired range. For example, a battery enclosure environmental controller may include a fan to cool battery cells if the battery cells exceed a threshold temperature. However, the battery enclosure environmental controller may consume battery energy to cool the battery. Therefore, it may be desirable to control the battery enclosure environment in a way that reduces battery energy consumption.

The inventors herein have recognized the above-mentioned disadvantages and have developed a method for controlling an energy storage device enclosure environment, comprising: opening a vehicle window in response to a temperature in a vehicle propulsion energy storage device enclosure exceeding a first threshold temperature.

By opening vehicle windows and transferring thermal energy from a vehicle's passenger compartment to an energy storage device enclosure, it may be possible to consume less energy from an energy storage device to maintain desired environmental conditions within the energy storage device enclosure. For example, if a temperature within an energy storage device enclosure is less than a desired temperature and outside ambient temperature is greater than the temperature in the energy storage device enclosure, passenger cabin or compartment windows may be opened so that outside ambient air may be drawn into the passenger cabin and the energy storage device enclosure. The warmer outside ambient air may be passed through the energy storage device enclosure to warm components of an energy storage device within the enclosure. Consequently, less energy may be used from an energy storage device to maintain temperature within the energy storage device enclosure. Further, in other examples, solar heating of the passenger cabin may be used to increase temperature within the energy storage device enclosure while the vehicle's windows are closed. Further still, other vehicle devices may be controlled to reduce energy used to maintain an energy storage device enclosure at desired conditions.

The present description may provide several advantages. Specifically, the approach may reduce an amount of stored energy used to maintain an energy storage device enclosure at desired conditions. Additionally, the approach may allow for more simplified control of conditions within an energy storage device enclosure. Further, the approach may allow for extended vehicle driving range by reducing power consumption within the energy storage device enclosure.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of a vehicle;

FIG. 2 is a schematic of a vehicle driveline;

FIG. 3 is a plot of an example operating sequence for controlling operating conditions within an energy storage device enclosure;

FIGS. 4 and 5 shows an example method for controlling conditions within an energy storage device enclosure; and

FIGS. 6A and 6B show schematics of example air flow diagram for an energy storage device enclosure.

### DETAILED DESCRIPTION

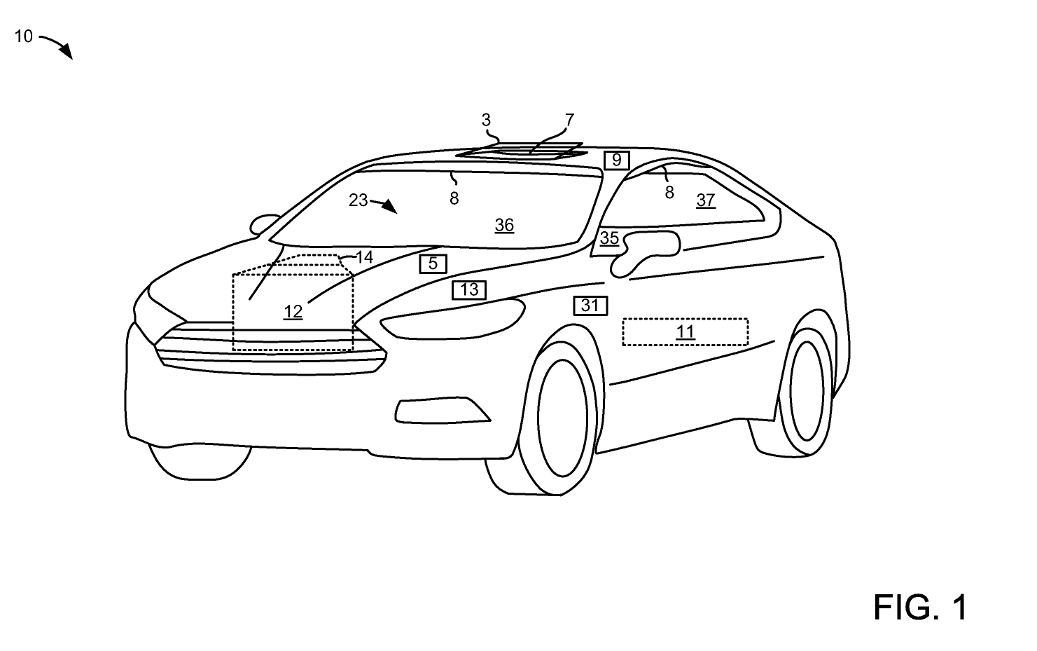

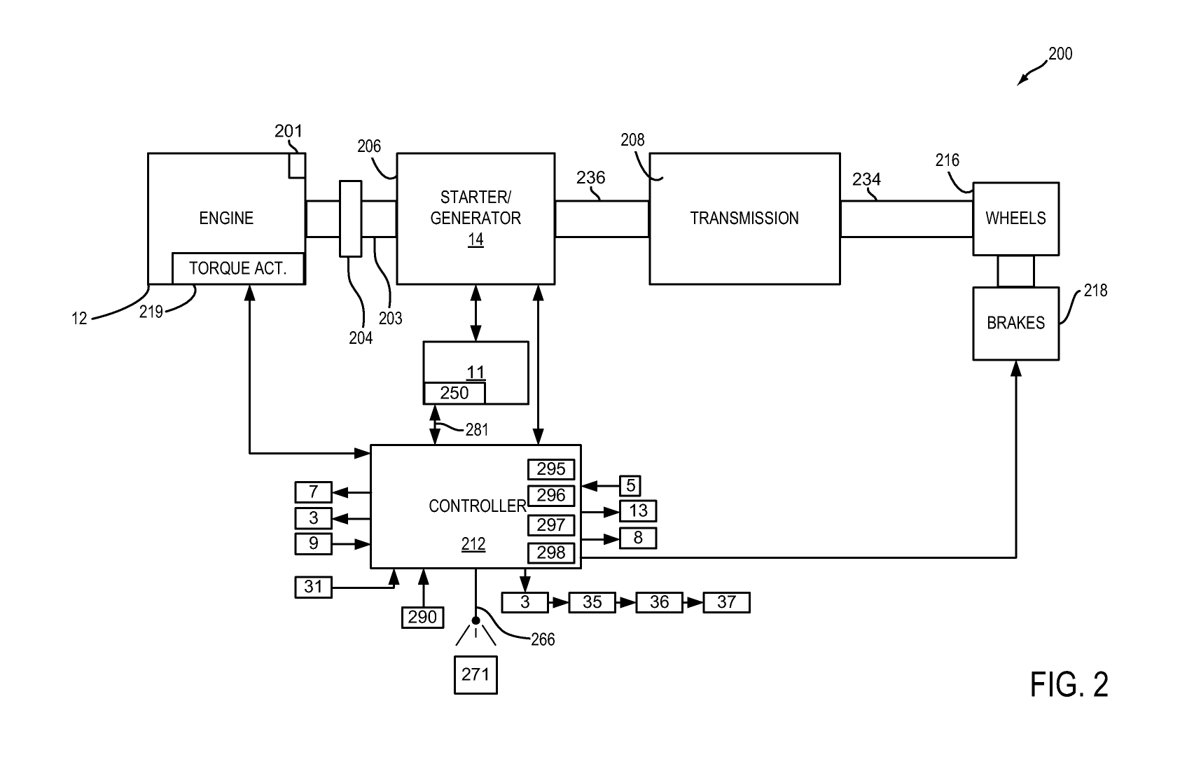

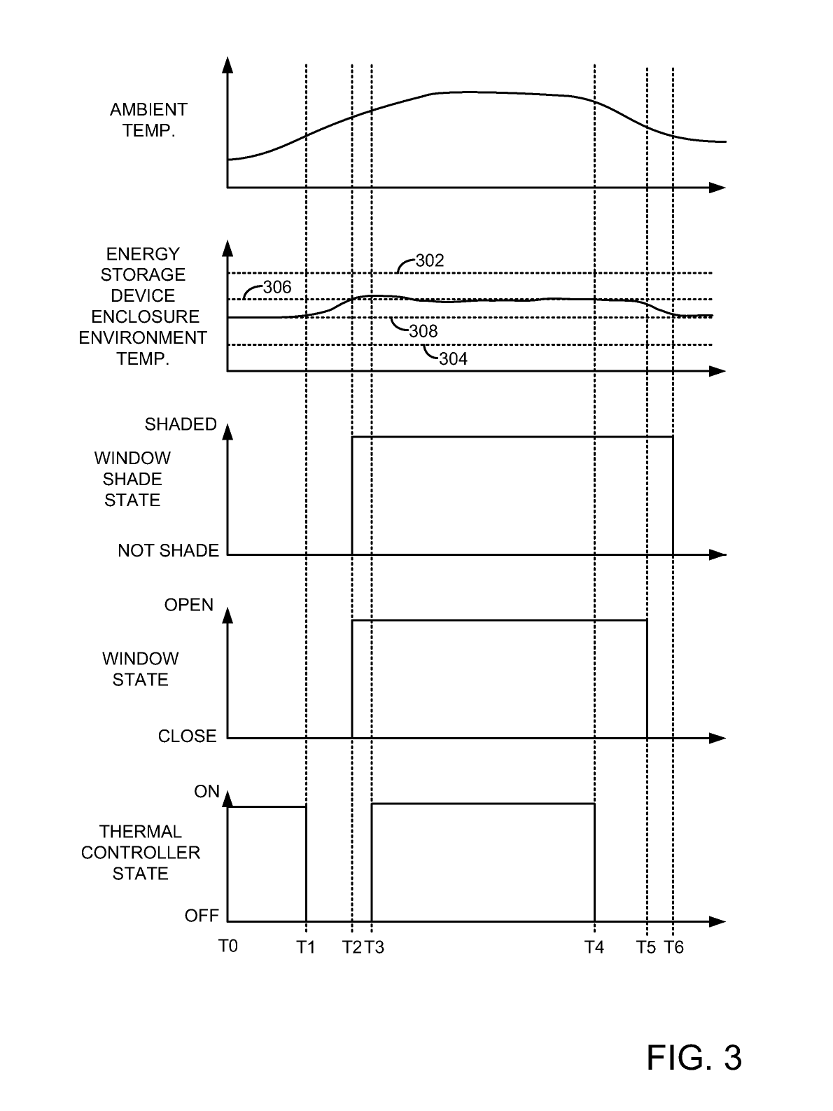

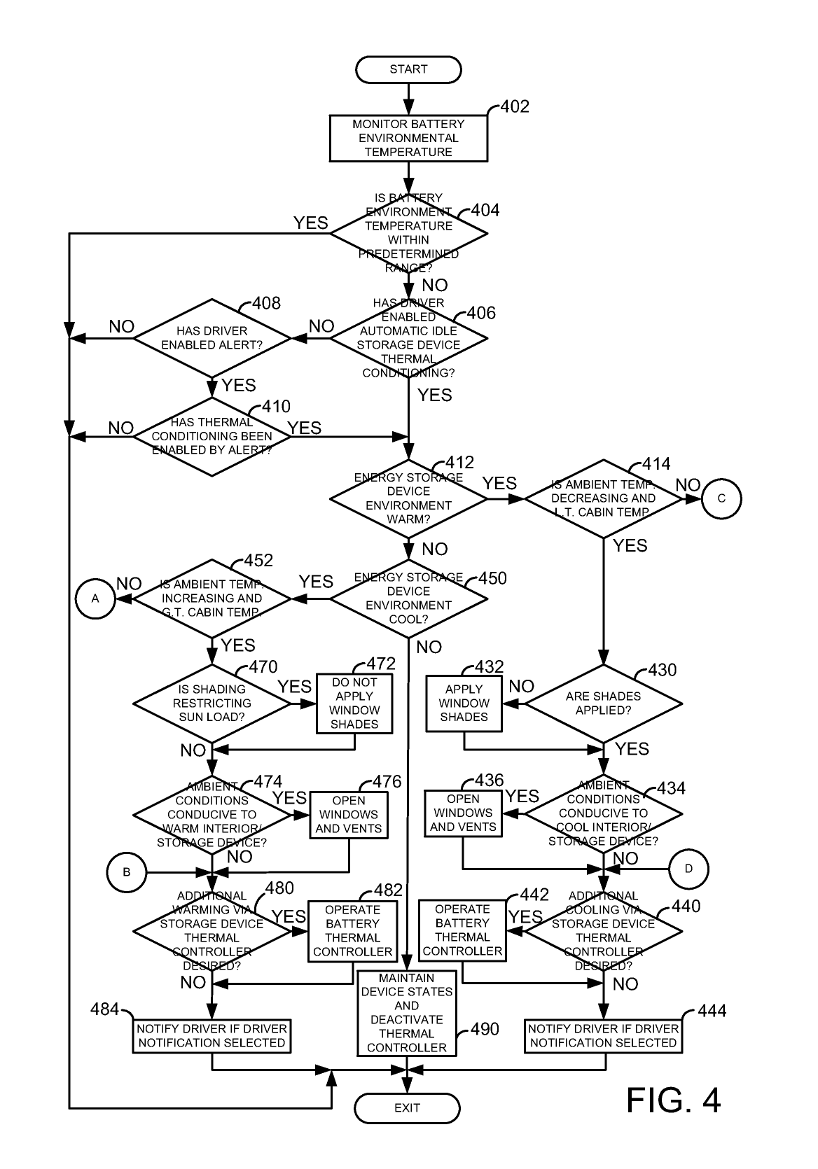

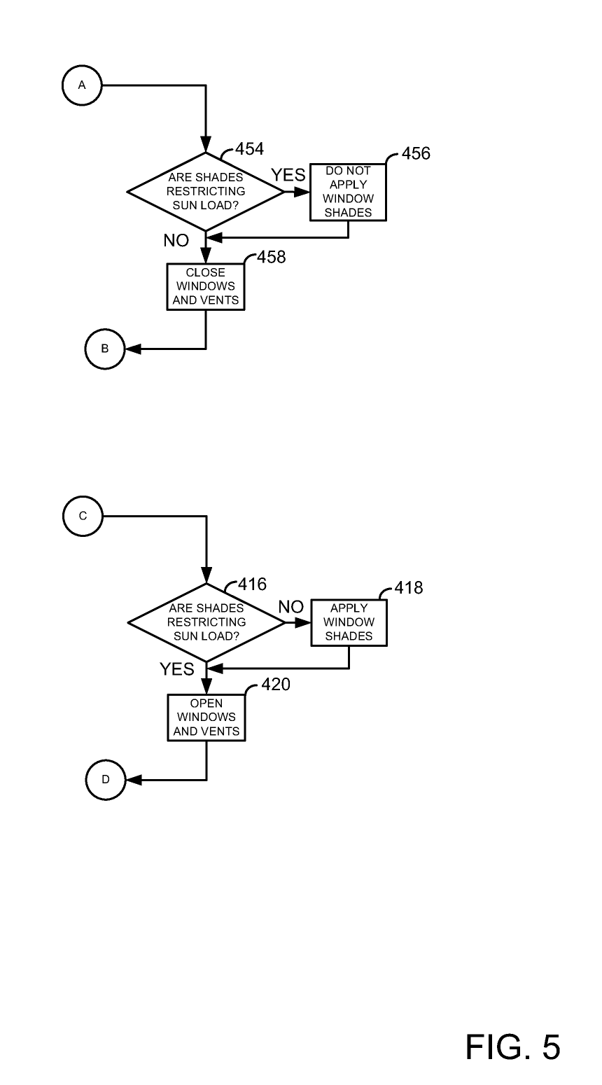

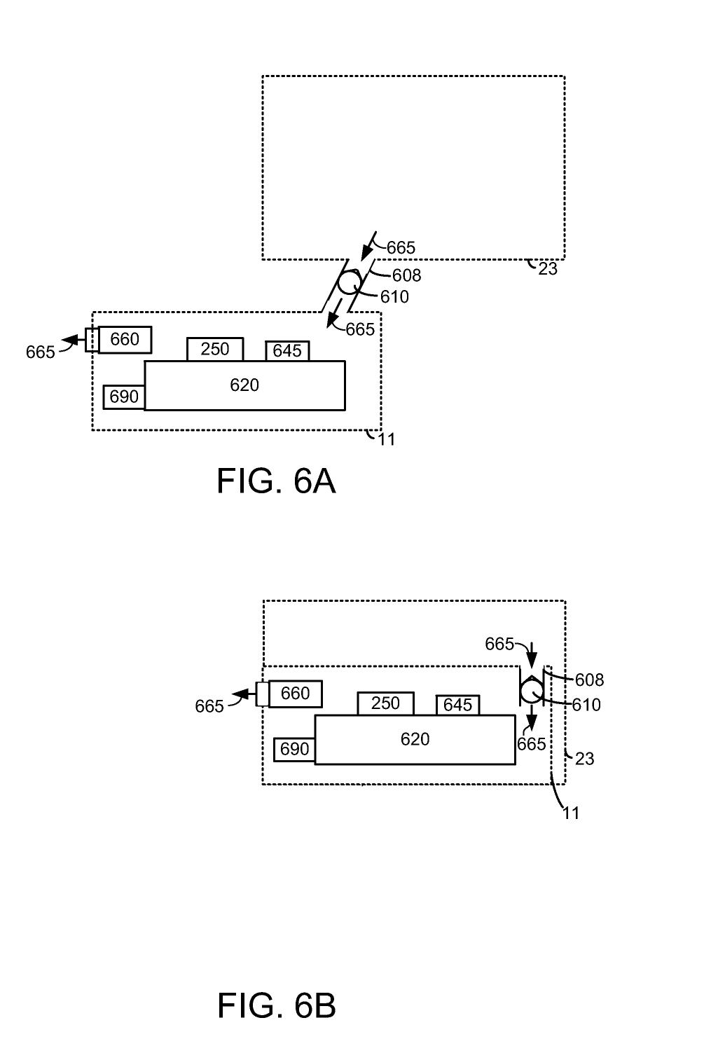

The present description is related to providing climate or environmental control for a vehicle energy storage device enclosure. Specifically, a method and system for providing heating and cooling to a vehicle's energy storage device enclosure is described. The energy storage device may be positioned external or internal of a vehicle's passenger cabin or compartment. One example passenger vehicle as is shown in FIG. 1. The vehicle may include a driveline as shown in FIG. 2. Conditions within the energy storage device enclosure may be controlled as shown in the sequence of FIG. 3. A method for controlling conditions within the energy storage device enclosure is shown in FIGS. 4 and 5. Finally, FIGS. 6A and 6B show example configurations for routing air to the vehicle's energy storage device enclosure.

Referring to FIG. 1, a vehicle 10 including an engine 12, an electrical machine 14, and an electrical energy storage device enclosure 11 is shown. In one example, the vehicle may be propelled solely via the engine 12, solely via an electrical machine 14, or by both the engine 12 and the electrical machine 14. The electrical machine 14 may be supplied electrical power via an energy storage device within the electrical energy storage device enclosure 11. The energy storage device in the electrical energy storage device enclosure 11 may be recharged via the vehicle's kinetic energy or via engine 12 providing power to electrical machine 14. The electric machine 14 may convert the vehicle's kinetic energy or engine torque into electrical energy which is stored in the electric energy storage device within electric energy storage device enclosure 11. The electrical energy storage device in the electrical energy storage device enclosure 11 may also be recharged from a stationary power grid via a home charging system or a remote charging system (e.g., a charging station). In one example, electrical energy storage device within the electrical energy storage device enclosure 11 is a battery. Alternatively, electrical energy storage device in the electric energy storage device enclosure 11 may be a capacitor or other storage device.

The vehicle 10 may include a driveline as shown in FIG. 2 or another suitable driveline to propel the vehicle 10 and/or power vehicle components. Vehicle 10 is shown with internal combustion engine 12, and it may be selectively coupled to an electric machine 14. Internal combustion engine 12 may combust petrol, diesel, alcohol, hydrogen, or a combination of fuels.

A driver or automatic controls may adjust positions or states of various devices to control passenger comfort and environmental conditions (e.g., temperature) with electric energy storage device enclosure 11. The various devices may include but are not limited to vents 13 for allowing ambient outdoor air into passenger cabin 23, side windows 37, front windscreen 36, rear windscreen 37, retractable window blinds 8, retractable sun/moon roof shade 7, and sun/moon roof 3. In some examples, the aforementioned devices may be adjusted in response to a solar load sensor 5, ambient outdoor temperature sensor 31, and/or a rain sensor 9. Further, side windows 37, front windscreen 36, rear windscreen 37, and sun/moon roof 3 may be electrically tinted. For example, a voltage or current may be applied to the windows to align particles within each of the windows, thereby reducing transmission of sun rays through the respective windows and the solar load applied to passenger cabin 23. The voltage or current may be removed from the windows to allow the particles to randomly distribute, thereby increasing transmission of sun rays through the respective windows.

Referring now to FIG. 2, an example vehicle driveline is shown. The vehicle driveline 200 includes an engine 12, disconnect clutch 204, driveline integrated starter/generator (DISG) 14, automatic transmission 208, wheels 216, and brakes 218. Disconnect clutch 204 may be selectively engaged and disengaged to allow or prevent torque transfer between engine 12 and DISG 14. Shaft 203 couples disconnect clutch 204 to DISG 14, and shaft 236 couples DISG to transmission 208. Output of transmission 208 is directed to wheels 216 via driveshaft 234.

Electric energy may be supplied from an electric energy storage device (not shown) within electric energy storage device enclosure 11 to DISG 14. Electric energy storage device controller 250 may control charging and discharging of the electric energy storage device within electric energy storage device enclosure 11. Further, electric energy storage device controller 250 may control environmental conditions (e.g., temperature) within electric energy storage device enclosure 11. Electric energy storage device controller 250 may communicate with driveline controller 212 via communications link 281.

Driveline controller 212 may control driveline actuators and receive information from driveline sensors. For example, driveline controller 212 may adjust engine torque actuator (e.g., fuel injector, throttle, camshaft, and/or ignition coil) 219 in response to vehicle operating conditions. Driveline controller 212 may also selectively open and close driveline disconnect clutch 204. DISG may be operated as a motor or generator in response to commands from driveline controller 212. Transmission 208 may be shifted through a group of stepped ratio gears in response to commands from driveline controller 212. Driveline controller 212 may also adjust positions and/or states of retractable sun/moon roof shade 7, sun/moon roof 3, vent 13, retractable window blinds 8, and in vehicle driver input device (e.g., push-button and/or display panel) 290. In one example, driveline controller 212 may also apply an electrical voltage to one or more of sun/moon roof 3, side window 35, front windscreen 36, and rear windscreen 37 to adjust tinting of the respective windows. Driveline controller 212 may also receive outdoor ambient information from rain sensor 9, temperature sensor 31, and sun load sensor (e.g., photovoltaic cell) 5. Controller 212 may transmit status of vehicle sensors and actuators to a driver remote from the vehicle via antenna 266. The status information may be transmitted to a driver that is remote from the vehicle via handheld device 271. Handheld device 271 may be a phone, computer, or other device.

Driveline controller may include a central processing unit (CPU) 295, non-transitory memory 296 for storing executable instructions such as the method of FIGS. 4 and 5, inputs and outputs 297, and random access memory 298. In one example, controller 212 includes instructions for communicating with controller 250 for adjusting actuators and relaying sensor information between controllers.

Thus, the system of FIGS. 1, 2, and 6A-6B provides for a vehicle system, comprising: an energy storage device enclosure; a passenger cabin; a conduit coupling the energy storage device enclosure and the passenger cabin; and a controller including executable instructions stored in non-transitory memory for controlling a temperature in the energy storage device enclosure via air from the passenger cabin. The vehicle system includes where the executable instructions include instructions to shade a window of a vehicle in response to a condition of the energy storage device enclosure. The vehicle system includes where the executable instructions include instructions to open and close a window of a vehicle in response to a condition of the energy storage device enclosure. The vehicle system includes where the executable instructions open and close the window in further response to a solar load on the passenger cabin. The vehicle system includes where the executable instructions open and close the window in further response to rain. The vehicle system further comprises additional instructions stored in non-transitory memory for notifying a driver at a location remote from the vehicle.

Referring now to FIG. 3, a plot of an example operating sequence for controlling operating conditions within an energy storage device enclosure is shown. The sequence of FIG. 3 may be provided by the system of FIGS. 1, 2, and 6A-6B according to the method of FIGS. 4 and 5. Vertical lines T0-T6 represent times of interest during the sequence.

The first plot from the top of FIG. 3 is a plot of ambient outdoor temperature versus time. The Y axis represents ambient temperature and the X axis represents time. Time increases from the left side of FIG. 3 to the right side of FIG. 3. Ambient temperature increases in the direction of the Y axis arrow.

The second plot from the top of FIG. 3 is a plot of energy storage device enclosure temperature versus time. The Y axis represents energy storage device enclosure temperature and temperature increases in the direction of the Y axis arrow. The X axis represents time and time increases from the left side of FIG. 3 to the right side of FIG. 3. Horizontal line 306 represents an upper bound of a desired electric energy storage device enclosure temperature. Horizontal line 308 represents a lower bound of a desired electric energy storage device enclosure temperature. Horizontal line 302 represents an upper bound of electric energy storage device enclosure temperature. Horizontal line 304 represents a lower bound of electric energy storage device enclosure temperature. Thus, the desired electric energy storage device enclosure temperature is within the upper and lower bounds of electric energy storage device enclosure temperature.

The third plot from the top of FIG. 3 is a plot of window shade state versus time. The Y axis represents window shade state (e.g., shaded or not shaded) and windows are shaded when the trace is at a higher level near the Y axis arrow. The X axis represents time and time increases from the left side of FIG. 3 to the right side of FIG. 3.

The fourth plot from the top of FIG. 3 is a plot of window state versus time. The Y axis represents window state (e.g., open or closed) and windows are open when the trace is at a higher level near the Y axis arrow. The X axis represents time and time increases from the left side of FIG. 3 to the right side of FIG. 3.

The fifth plot from the top of FIG. 3 is a plot of battery thermal controller state versus time. The Y axis represents thermal controller state (e.g., off or on) and thermal controller is active when the trace is at a higher level near the Y axis arrow. The X axis represents time and time increases from the left side of FIG. 3 to the right side of FIG. 3. The thermal controller may heat or cool the electric energy storage enclosure using electrical energy stored in an electric energy storage device that is housed in the enclosure.

At time T0, ambient outdoor temperature is low and electric energy storage enclosure temperature is at a lower temperature in the desired electric energy storage device enclosure temperature range. Vehicle window shades are not shaded and vehicle windows are closed. The vehicle window shaded may be open and vehicle windows may be closed when outside ambient temperature is cooler than passenger cabin temperature or electric energy storage enclosure temperature. By opening vehicle window shades and closing vehicle windows, passenger cabin temperature may be increased via solar energy. The thermal controller is also active in a heating mode. The thermal controller provides heat to the electric energy storage device enclosure to maintain enclosure temperature between desired limits 306 and 308. In one example, the electric energy storage device enclosure may be heated using resistive heating. The thermal controller may be activated if electric energy storage device temperature is not maintained within desired limits 306 and 308 after a predetermined amount of time or after select conditions are met.

Between time T0 and time T1, outside ambient temperature begins to rise. Further, the electric energy storage device temperature begins to rise near time T1 in response to temperature rising in the passenger cabin due to solar heating (not shown). Air from the passenger cabin may be drawn into the electric energy storage device enclosure when air temperature in the passenger cabin is greater than a temperature in the electric energy storage device enclosure at a time when warming of the electric energy storage device enclosure is desired.

At time T1, the thermal controller is deactivated since temperature in the electric energy storage device enclosure has increased. By deactivating the thermal controller and heating the electric energy storage device enclosure via cabin heat, it may be possible to conserve energy stored in the electric energy storage device. The outdoor ambient temperature continues to increase and the vehicle window shades remain in a state where the vehicle cabin is not shaded. The vehicle windows remain in a closed position to increase heating of the vehicle cabin.

Between time T1 and time T2, the ambient outdoor temperature continues to increase and the electric energy storage device enclosure also increases in response to increasing passenger cabin temperature (not shown). The windows remain unshaded and in a closed state. The thermal controller remains deactivated.

At time T2, the electric energy storage device enclosure temperature reaches threshold 306 in response to increasing passenger cabin temperature (not shown). The vehicle window shades close in response to temperature in the electric energy storage device enclosure. However, the vehicle window shades may also be closed in response to passenger cabin temperature exceeding a threshold temperature. The vehicle windows are also at least partially opened in response to electric energy storage device enclosure. The thermal controller remains deactivated. The ambient outside temperature continues to increase.

At time T3, the electric energy storage device enclosure temperature has been greater than threshold 306 for a predetermined amount of time. Therefore, the thermal controller is activated in a cooling mode to begin cooling the electric energy storage device enclosure. The vehicle window shades are shading the vehicle passenger cabin and the vehicle windows are at least partially open. The outdoor ambient temperature continues to increase and the electric energy storage device enclosure begins to be reduced toward temperature level 306.

Between time T3 and time T4, the ambient outdoor temperature stabilizes at a higher level and the electric energy storage device enclosure temperature remains near temperature level 306. The window shades remain applied and the windows remain partially open. The thermal controller also remains active.

At time T4, the ambient outdoor temperature has decrease and so has the electric energy storage device enclosure temperature in response to a decrease in passenger cabin temperature. Air from the passenger cabin is circulated through the electric energy storage device enclosure, thereby cooling the electric energy storage device enclosure. The thermal controller is deactivated in response to the electric energy storage device enclosure temperature (e.g., the temperature inside the electric energy storage device enclosure). The vehicle window shades remain applied and the vehicle windows remain at least partially open.

At time T5, the ambient outdoor temperature has been reduced to a lower level and the vehicle windows are closed in response to the reduced electric energy storage device enclosure temperature. The vehicle windows may also be closed in response to passenger cabin temperature. The window shades remain in an applied state.

At time T6, the ambient outdoor temperature has been reduced to an even lower level and the vehicle window shades are not applied in response to the reduced electric energy storage device enclosure temperature. The vehicle window shades may also be not applied in response to passenger cabin temperature. The vehicle windows remain closed and the thermal controller remains deactivated.

Thus, the system of FIGS. 1, 2, and 6A-6B utilizes warmer or cooler air from the passenger cabin to control temperature within an electric energy storage device enclosure so that the thermal controller may use less electrical energy from an electric energy storage device. Further, air from the passenger cabin may be used to cool the electric energy storage device enclosure when an electric energy storage device within the enclosure is being charged at a grid charging station while the vehicle is not occupied.

Referring now to FIGS. 4 and 5, a method for controlling conditions within an energy storage device enclosure is shown. The method of FIGS. 4 and 5 may be stored in non-transitory memory of a controller as executable instructions of the system shown in FIGS. 1, 2, and 6A-6B. Further, the method of FIGS. 4 and 5 may provide the operating sequence shown in FIG. 3.

At 402, method 400 monitors electric energy storage device enclosure interior conditions. In one example, conditions such as temperature, humidity, and pressure may be determined via sensors located within the electric energy storage device enclosure. Further, method 400 may determine outside ambient temperature, pressure, solar load, and whether or not rain is present. Further still, method 400 may determine passenger cabin temperature. Method 400 proceeds to 404 after environmental conditions are determined.

At 404, method 400 judges whether or not temperature within the electric energy storage device enclosure is within a predetermined temperature range. If method 400 judges that temperature in the electric energy storage device enclosure is within the predetermined temperature range, the answer is yes and method 400 proceeds to exit. Otherwise, the answer is no and method 400 proceeds to 406. In some examples, method 400 may not include step 404 so that vehicle shades and windows may always be adjusted if enabled by the driver.

At 406, method 400 judges whether or not a driver has enabled automatic idle energy storage device thermal conditioning. In other words, method 400 judges if the driver has enabled control of the electric energy storage device enclosure environmental conditions. In one example, the driver may activate automatic control of the electric energy storage device enclosure environmental conditions via a pushbutton or user display panel. If method 400 judges that automatic idle energy storage device thermal conditioning has been enabled, the answer is yes and method 400 proceeds to 412. Otherwise, the answer is no and method 400 proceeds to 408.

At 408, method 400 judges whether or not the driver has enabled an energy storage device thermal conditioning alert. The alert may be provided in the form of email, text message, or other user specific notification method. An alert may be transmitted to the driver if energy storage device enclosure environmental conditions (e.g., temperature) are outside of a desired range and alert has been enabled. If method 400 judges that alert has been enabled, the answer is yes and method 400 proceeds to 410. Otherwise, the answer is no and method 400 proceeds to exit.

At 410, method 400 judges whether or not a driver has enabled automatic idle energy storage device thermal conditioning via an alert. In one example, the driver may activate automatic control of the electric energy storage device enclosure environmental conditions via the alert by texting confirming activation of automatic control of the electric energy storage device enclosure environmental conditions. If method 400 judges that automatic idle energy storage device thermal conditioning has been enabled via alert, the answer is yes and method 400 proceeds to 412. Otherwise, the answer is no and method 400 proceeds to exit.

At 412, method 400 judges whether or not the electric energy storage device enclosure is warmer than desired. If so, the answer is yes and method 400 proceeds to 414. Otherwise, the answer is no and method 400 proceeds to 450.

At 414, method 400 judges whether or not outdoor ambient temperature is decreasing and if ambient temperature is less than (L.T.) passenger cabin temperature. If so, the answer is yes and method 400 proceeds to 430. Otherwise, the answer is no and method 400 proceeds to 416 or FIG. 5. Alternatively, or in addition, method 400 may judge whether or not passenger cabin temperature is less than the electric energy storage device enclosure temperature. If so, method 400 proceeds to 430. Otherwise, method 400 proceeds to 416.

At 416, method 400 judges whether or not shading devices are restricting the sun load to the passenger cabin. For example, method 400 judges if the window shades including sun roof shades are shading the passenger cabin. If not, the answer is no and method 400 proceeds to 418. If so, method 400 proceeds to 420.

At 418, method 400 applies shading to vehicle windows. Shading may be provided by closing power shades that cover vehicle windows including sun/moon roofs or via applying a voltage or current to windows to align particles within the windows to shade the vehicle passenger cabin. However, sun/moon roof shades may be left partially open to allow air flow through the sun/moon roof. Method 400 proceeds to 420 after vehicle windows are shaded.

At 420, method 400 opens vehicle windows including side windows and sun/moon roof, if a sun/moon roof is present. Windows may be opened via applying power to window motors. Method 400 proceeds to 440 after vehicle windows are opened.

In this way, if outdoor ambient temperature is increasing when the electric energy storage device enclosure temperature is warmer than desired, the passenger cabin may be shaded while vehicle windows are open to reduce the possibility of the passenger cabin temperature increasing to a temperature greater than outdoor ambient temperature. Consequently, air drawn from the passenger cabin to the electric energy storage device enclosure may be limited to a lower temperature to improve electric energy storage device enclosure cooling.

At 430, method 400 judges whether or not window shading, including sun/moon roof shading, is applied (e.g., if shades are closed or providing shading to the passenger cabin). Method 400 may judge whether or not window shading is applied based on positions of limit switches or based on voltage or current output to shading devices. If method 400 judges that shading is applied, the answer is yes and method 400 proceeds to 434. Otherwise, the answer is no and method 400 proceeds to 432.

At 432, method 400 applies shading to vehicle windows. Shading may be provided by closing power shades that cover vehicle windows including sun/moon roofs or via applying a voltage or current to windows to align particles within the windows to shade the vehicle passenger cabin. However, sun/moon roof shades may be left partially open to allow air flow through the sun/moon roof. Method 400 proceeds to 434 after vehicle windows are shaded.

At 434, method 400 judges whether or not outdoor ambient conditions are conducive to cooling the electric energy storage device enclosure. In one example, method 400 may judge whether or not outdoor ambient conditions are conducive to cooling the electric energy storage device enclosure based on if outdoor ambient temperature is less than passenger cabin temperature. Alternatively, or additionally, method 400 may judge whether or not passenger cabin temperature is less than electric energy storage device enclosure temperature. If method 400 judges that conditions are conducive to cool the electric energy storage device enclosure and/or passenger cabin temperature is less than electric energy storage device enclosure temperature, the answer is yes and method 400 proceeds to 436. Otherwise, the answer is no and method 400 proceeds to 440.

At 436, method 400 opens vehicle windows including side windows and sun/moon roof, if a sun/moon roof is present. Windows may be opened via applying power to window motors. Additionally, passenger cabin vents may be opened. Method 400 proceeds to 440 after vehicle windows are opened.

At 440, method 400 judges whether or not additional cooling via an electric energy storage device enclosure thermal controller is desired. In one example, method 400 may judge that additional cooling via an electric energy storage device enclosure thermal controller is desired if electric energy storage device enclosure temperature is not within a desired temperature range within a predetermined amount of time or if electric energy storage device enclosure temperature increases at more than a predetermined rate. If method 400 judges that additional cooling via an electric energy storage device enclosure thermal controller is desired, method 400 proceeds to 442. Otherwise, the answer is no and method 400 proceeds to 444.

At 442, method 400 operates the electric energy storage device enclosure thermal controller to cool the electric energy storage device enclosure. The electric energy storage device enclosure thermal controller may activate a fan and/or circulate coolant through the electric energy storage device enclosure to cool the electric energy storage device enclosure and its contents. In one example, the thermal controller adjusts temperature in the electric energy storage device enclosure to an upper limit of a desired temperature range when thermal energy in the electric energy storage device enclosure is increasing. By controlling the electric energy storage device enclosure temperature to the upper limit of the desired temperature range, it may be possible to lower energy use by the thermal energy controller. Method 400 proceeds to 444 after the thermal controller is activated.

At 444, method 400 notifies a driver of actions taken to cool the electric energy storage device enclosure. In one example, method 400 transmits vehicle window status (e.g., open or closed), vehicle shade status (e.g., applied or not applied), ambient outdoor temperature, and electric energy storage device enclosure temperature to the driver from an antenna to a personal device, such as a phone or computer, if the driver has selected to be notified of vehicle status. Method 400 proceeds to exit after the driver is notified.

In this way, vehicle shades may be activated or applied and windows and vents may be opened to cool the passenger cabin interior during conditions where outside ambient temperature is decreasing. Cooling the passenger cabin interior may help to cool the electric energy storage device enclosure since air may be drawn from the passenger cabin into the electric energy storage device enclosure. Consequently, less energy from the electric energy storage device may be used to control temperature in the electric energy storage device enclosure so that vehicle driving range may be extended.

At 450, method 400 judges whether or not the electric energy storage device enclosure is cooler than desired. If so, the answer is yes and method 400 proceeds to 452. Otherwise, the answer is no and method 400 proceeds to 490.

At 490, method 400 holds or maintains the operating states of vehicle windows, vents, and shades. Further, method 400 may deactivate the electric energy storage device enclosure thermal controller to conserve energy. Method 400 proceeds to exit after operating states are held at their respective present states.

Additionally, in some examples, method 400 may close windows at any step if rain is detected via a rain sensor or if conditions indicate that the vehicle is being tampered with. For example, if a vehicle door handle is operated without a proper vehicle unlock data sequence being received (e.g., via a key pad or transmitted signal), the windows may be closed. Further, the opening amounts of windows may be varied in response to solar load as determined from electrical output of a photovoltaic cell.

At 452, method 400 judges whether or not outdoor ambient temperature is increasing and if ambient temperature is greater than (G.T.) passenger cabin temperature. If so, the answer is yes and method 400 proceeds to 470. Otherwise, the answer is no and method 400 proceeds to 454 or FIG. 5. Alternatively, or in addition, method 400 may judge whether or not passenger cabin temperature is greater than the electric energy storage device enclosure temperature. If so, method 400 proceeds to 470. Otherwise, method 400 proceeds to 454.

At 454, method 400 judges whether or not shading devices are restricting the sun load to the passenger cabin. For example, method 400 judges if the window shades including sun roof shades are shading the passenger cabin. If not, the answer is no and method 400 proceeds to 458. If so, method 400 proceeds to 456.

At 456, method 400 deactivates or reduces shading to vehicle windows. Shading may be reduced by opening power shades that cover vehicle windows including sun/moon roofs or via reducing a voltage or current to windows to align particles within the windows to shade the vehicle passenger cabin. Method 400 proceeds to 458 after vehicle windows are shaded.

At 458, method 400 closes vehicle windows including side windows and sun/moon roof, if a sun/moon roof is present. Windows may be closed via applying power to window motors. Method 400 proceeds to 480 after vehicle windows are opened.

In this way, if outdoor ambient temperature is increasing when the electric energy storage device enclosure temperature is cooler than desired, the passenger cabin may be unshaded while vehicle windows are closed to increase the possibility of the passenger cabin temperature increasing to a temperature greater than outdoor ambient temperature. Consequently, air drawn from the passenger cabin to the electric energy storage device enclosure may be increased to a higher temperature to improve electric energy storage device enclosure warming.

At 470, method 400 judges whether or not window shading, including sun/moon roof shading, is applied (e.g., if shades are closed or providing shading to the passenger cabin). Method 400 may judge whether or not window shading is applied based on positions of limit switches or based on voltage or current output to shading devices. If method 400 judges that shading is applied, the answer is yes and method 400 proceeds to 472. Otherwise, the answer is no and method 400 proceeds to 474.

At 472, method 400 removes shading from vehicle windows. Shading may be removed by opening power shades that cover vehicle windows including sun/moon roofs or via removing or reducing a voltage or current applied to windows to align particles within the windows. Method 400 proceeds to 474 after vehicle windows are shaded.

At 474, method 400 judges whether or not outdoor ambient conditions are conducive to warming the electric energy storage device enclosure. In one example, method 400 may judge whether or not outdoor ambient conditions are conducive to warming the electric energy storage device enclosure based on if outdoor ambient temperature is greater than passenger cabin temperature. Alternatively, or additionally, method 400 may judge whether or not passenger cabin temperature is greater than electric energy storage device enclosure temperature. If method 400 judges that conditions are conducive to warm the electric energy storage device enclosure and/or passenger cabin temperature is greater than electric energy storage device enclosure temperature, the answer is yes and method 400 proceeds to 476. Otherwise, the answer is no and method 400 proceeds to 480.

At 476, method 400 opens vehicle windows including side windows and sun/moon roof, if a sun/moon roof is present. Windows may be opened via applying power to window motors. Additionally, passenger cabin vents may be opened. Method 400 proceeds to 480 after vehicle windows are opened.

At 480, method 400 judges whether or not additional warming via an electric energy storage device enclosure thermal controller is desired. In one example, method 400 may judge that additional warming via an electric energy storage device enclosure thermal controller is desired if electric energy storage device enclosure temperature is not within a desired temperature range within a predetermined amount of time or if electric energy storage device enclosure temperature decreases at more than a predetermined rate. If method 400 judges that additional warming via an electric energy storage device enclosure thermal controller is desired, method 400 proceeds to 482. Otherwise, the answer is no and method 400 proceeds to 484.

At 482, method 400 operates the electric energy storage device enclosure thermal controller to warm the electric energy storage device enclosure. The electric energy storage device enclosure thermal controller may activate resistive heaters and/or circulate warmed fluid through the electric energy storage device enclosure to warm the electric energy storage device enclosure and its contents. In one example, the thermal controller adjusts temperature in the electric energy storage device enclosure to a lower limit of a desired temperature range when thermal energy in the electric energy storage device enclosure is decreasing. By controlling the electric energy storage device enclosure temperature to the lower limit of the desired temperature range, it may be possible to lower energy use by the thermal energy controller. Method 400 proceeds to 484 after the thermal controller is activated.

At 484, method 400 notifies a driver of actions taken to warm the electric energy storage device enclosure. In one example, method 400 transmits vehicle window status (e.g., open or closed), vehicle shade status (e.g., applied or not applied), ambient outdoor temperature, and electric energy storage device enclosure temperature to the driver from an antenna to a personal device, such as a phone or computer, if the driver has selected to be notified of vehicle status. Method 400 proceeds to exit after the driver is notified.

In this way, vehicle shades may be removed and windows and vents may be opened to warm the passenger cabin interior during conditions where outside ambient temperature is increasing and electric energy storage device enclosure temperature is low. Warming the passenger cabin interior may help to warm the electric energy storage device enclosure since air may be drawn from the passenger cabin into the electric energy storage device enclosure.

Thus, the method of FIGS. 4 and 5 provides for a method for controlling an energy storage device enclosure environment, comprising: opening a vehicle window in response to a temperature in a vehicle propulsion energy storage device enclosure exceeding a first threshold temperature. The method further comprises closing the vehicle window in response to the temperature in the vehicle propulsion energy storage device being less than a second threshold temperature. The method includes where the vehicle window is a sun roof or moon roof. The method includes where a position of the vehicle window is adjusted to an open state in further response to an ambient outdoor temperature being less than the temperature in the vehicle propulsion energy storage device enclosure and where the position of the vehicle window is adjusted to a closed state in further response to ambient outdoor temperature being greater than the temperature in the vehicle propulsion energy storage device enclosure.

In one example, the method further comprises drawing air from a vehicle passenger cabin into the vehicle propulsion energy storage device enclosure. The method includes where the air from the vehicle passenger cabin is drawn through a one-way valve. The method further comprises notifying a driver of opening the window at a location remote from the vehicle.

The method of FIGS. 4 and 5 also provides for a method for controlling an energy storage device enclosure environment, comprising: shading a window in response to a temperature in a vehicle propulsion energy storage device enclosure exceeding a first threshold temperature. The method includes where shading the window includes tinting the window via applying an electrical current to the window. The method includes where shading the window includes drawing a blind over the window. The method further comprises removing shading from a window in response to the temperature storage device enclosure being less than a second threshold temperature. The method further comprises opening passenger cabin vents in response to the temperature in the vehicle propulsion energy storage device enclosure exceeding the first threshold temperature. The method further comprises activating a battery thermal controller in response to the temperature in a vehicle propulsion energy storage device enclosure exceeding the first threshold temperature for greater than a threshold period of time. The method includes where air is drawn from a vehicle's passenger cabin into the vehicle propulsion energy storage device enclosure, and where the vehicle propulsion energy storage device enclosure houses a battery for propelling a vehicle.

Referring now to FIG. 6A, a first example schematic illustrating air flow for an energy storage device enclosure is shown. The systems shown in FIG. 6A may be part of the system shown in FIGS. 1 and 2. Passenger cabin 23 is coupled to electric energy storage device enclosure 11 via conduit 608. One-way valve 610 is provided along the length of conduit 608 so that air flows only from passenger cabin 23 to electric energy storage device enclosure 11, and not vise-versa. Electric energy storage device enclosure 11 is shown including a thermal controller 250, battery cells 620, or alternatively, capacitors 620, resistive or PTC heater 645, temperature sensor 690, and fan 660. Fan 660 may draw air from passenger cabin 23 through Electric energy storage device enclosure 11 and out to atmosphere in the direction of arrows 666 when activated. In this example, electric energy storage device enclosure 11 is external with respect to passenger cabin 23.

Referring now to FIG. 6B, a second example schematic illustrating air flow for an energy storage device enclosure is shown. The systems shown in FIG. 6B may be part of the system shown in FIGS. 1 and 2. Passenger cabin 23 houses electric energy storage device enclosure 11 and is coupled to electric energy storage device enclosure 11 via conduit 608. One-way valve 610 is provided along the length of conduit 608 so that air flows only from passenger cabin 23 to electric energy storage device enclosure 11, and not vise-versa. Electric energy storage device enclosure 11 is shown including a thermal controller 250, battery cells 620, or alternatively, capacitors 620, resistive or PTC heater 645, temperature sensor 690, and fan 660. Fan 660 may draw air from passenger cabin 23 through Electric energy storage device enclosure 11 and out to atmosphere in the direction of arrows 666 when activated.

As will be appreciated by one of ordinary skill in the art, method described in FIGS. 4 and 5 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used. Further, the described actions, operations, methods, and/or functions may graphically represent code to be programmed into non-transitory memory of the computer readable storage medium in the vehicle control system.

This concludes the description. The reading of it by those skilled in the art would bring to mind many alterations and modifications without departing from the spirit and the scope of the description. For example, vehicles including electric, hybrid, or internal combustion engine propulsion systems could use the present description to advantage.

1. A method for controlling an energy storage device enclosure environment, comprising:
opening a vehicle window in response to a temperature in a vehicle propulsion energy storage device enclosure exceeding a first threshold temperature.

2. The method of claim 1, further comprising closing the vehicle window in response to the temperature in the vehicle propulsion energy storage device being less than a second threshold temperature.

3. The method of claim 1, where the vehicle window is a sun roof or moon roof.

4. The method of claim 1, where a position of the vehicle window is adjusted to an open state in further response to an ambient outdoor temperature being less than the temperature in the vehicle propulsion energy storage device enclosure and where the position of the vehicle window is adjusted to a closed state in further response to ambient outdoor temperature being greater than the temperature in the vehicle propulsion energy storage device enclosure.

5. The method of claim 1, further comprising drawing air from a vehicle passenger cabin into the vehicle propulsion energy storage device enclosure.

6. The method of claim 5, where the air from the vehicle passenger cabin is drawn through a one-way valve.

7. The method of claim 1, further comprising notifying a driver of opening the window at a location remote from the vehicle.

8. A method for controlling an energy storage device enclosure environment, comprising:
shading a window in response to a temperature in a vehicle propulsion energy storage device enclosure exceeding a first threshold temperature.

9. The method of claim 8, where shading the window includes tinting the window via applying an electrical current to the window.

10. The method of claim 8, where shading the window includes drawing a blind over the window.

11. The method of claim 8, further comprising removing shading from a window in response to the temperature storage device enclosure being less than a second threshold temperature.

12. The method of claim 8, further comprising opening passenger cabin vents in response to the temperature in the vehicle propulsion energy storage device enclosure exceeding the first threshold temperature.

13. The method of claim 8, further comprising activating a battery thermal controller in response to the temperature in a vehicle propulsion energy storage device enclosure exceeding the first threshold temperature for greater than a threshold period of time.

14. The method of claim 8, where air is drawn from a vehicle's passenger cabin into the vehicle propulsion energy storage device enclosure, and where the vehicle propulsion energy storage device enclosure houses a battery for propelling a vehicle.

15. A vehicle system, comprising:
an energy storage device enclosure;
a passenger cabin;
a conduit coupling the energy storage device enclosure and the passenger cabin; and
a controller including executable instructions stored in non-transitory memory for controlling a temperature in the energy storage device enclosure via air from the passenger cabin.

16. The vehicle system of claim 15, where the executable instructions include instructions to shade a window of a vehicle in response to a condition of the energy storage device enclosure.

17. The vehicle system of claim 15, where the executable instructions include instructions to open and close a window of a vehicle in response to a condition of the energy storage device enclosure.

18. The vehicle system of claim 17, where the executable instructions open and close the window in further response to a solar load on the passenger cabin.

19. The vehicle system of claim 17, where the executable instructions open and close the window in further response to rain.

20. The vehicle system of claim 19, further comprising additional instructions stored in non-transitory memory for notifying a driver at a location remote from the vehicle.
